(19) United States
(12) Patent Application Publication
(10) Pub. No.: US 2026/0182608 A1
(43) Pub. Date: Jul. 2, 2026

(54) FOOD OR BEVERAGE INGREDIENT COMPOSITION

(71) Applicant: SOCIETE DES PRODUITS NESTLE S.A., Vevey (CH)

(72) Inventors: EDWIN ANANTA, Epalinges (CH); WEN WANG, Singapore (SG); KORINA TERRAZAS VELARDE, Konolfingen (CH); CHING THENG TAN, Johor Bahru (MY); SAMANTHA LIEW, Singapore (SG); SEINN LAE WAING, Singapore (SG)

(21) Appl. No.: 19/549,547

(22) Filed: Feb. 25, 2026

Related U.S. Application Data
(62) Division of application No. 18/565,676.

(30) Foreign Application Priority Data
Jun. 1, 2021 (SG) 10202105808V

(51) Int. Cl. A23L 7/104; A23C 11/10; A23L 7/10; A23L 9/20; A23P 10/40

(52) U.S. Cl. CPC A23L 7/107; A23C 11/10; A23L 7/115; A23L 9/24; A23P 10/40

(57) ABSTRACT

A food or beverage ingredient is produced from enzymatically hydrolysed cereal, by contacting a slurry of cereal bran with an enzyme composition including xylanase, alpha-amylase, beta-glucanase, cellulase and endoprotease. A beverage creamer composition may contain the food or beverage ingredient.

### CROSS REFERENCE TO RELATED APPLICATIONS

The present application is a divisional of U.S. patent application Ser. No. 18/565,676, filed on Nov. 30, 2023, which is a National Stage of International Application No. PCT/EP2022/064193 filed May 25, 2022, which claims priority to Singapore patent application Ser. No. 10202105808V filed Jun. 1, 2021, the entire contents of which are incorporated herein by reference.

### FIELD OF THE INVENTION

The present invention relates to the field of food and beverage ingredients, particularly a food or beverage ingredient produced from hydrolysed cereal bran, a method of producing it and uses of such food ingredient.

### BACKGROUND

Many food and beverage products contain high amounts of sugar, often in the form of glucose syrup. Glucose syrup may be undesirable for nutritional reasons, and to increase the nutritional profile there is a desire to replace glucose syrup with components with a better nutritional profile while retaining taste, aroma, texture and other characteristics. Glucose syrup does not only contribute to sweetness but may also contribute to texture and volume of many food and beverage products as well as affect the processability during production of the food or beverage material. Synthetic sweeteners, often added in very small amount, can contribute sweetness but may lead to lower product volume as well as different texture and process characteristics of the products. There is a need for improved food ingredients to replace glucose syrup which do not only contribute sweetness and improve the nutritional quality of the product but also maintains similar texture and volume as glucose syrup sweetened products. An example of a food and beverage product is beverage creamers which are used to add to beverages such as coffee and/or tea. Beverage creamers may e.g. be in powdered form and glucose syrup may contribute to the volume of the powder as well as the mouthfeel obtained when adding the creamer to a beverage. Furthermore, powdered beverage creamers are usually produced by drying a liquid emulsion comprising the components of the creamer product. It is important that the liquid composition can be dried in an efficient way resulting in a free-flowing powder that is easily dissolved when added to the intended beverage. There is a desire to completely or in part replace glucose syrup and improve the nutritional profile of such creamers and therefore a need for food and beverage ingredients that can replace glucose syrup while maintaining sweetness, volume, efficient drying and final powder properties and improve the nutritional profile, e.g. by providing dietary fiber.

### SUMMARY

The inventors have found that cereal bran can be hydrolysed by a specific combination of enzymes to produce a food and beverage ingredient which can be used to replace glucose syrup in food and beverage products, e.g. in a powdered creamer composition, improving the nutritional profile of the product by increasing the content of dietary fiber. Accordingly, the present invention relates to a food or beverage ingredient comprising: 5-20% by weight of dry matter of protein; 0.1-15% by weight of dry matter of fat; 2-45% by weight of dry matter of dietary fiber; 5-35% by weight of dry matter of sugar; and 70-94% by weight of dry matter of total carbohydrate; wherein said protein, fat, dietary fiber, sugar and total carbohydrate is derived from enzymatically hydrolysed cereal bran. In further aspects the invention relates to a method of producing a food and beverage ingredient, a creamer composition and methods of producing a creamer composition.

### DETAILED DESCRIPTION

Cereal bran according to the invention may be the bran of any cereal. In a preferred embodiment, cereal bran is selected from the group consisting of rice, oat, corn, wheat, maize, barley, rye and triticale bran and combinations thereof.

### Food or Beverage Ingredient

By a food or beverage ingredient is meant a composition which is suitable to be added to a food or beverage composition intended for consumption by humans and/or animals.

The present invention provides a food or beverage ingredient comprising protein, fat, dietary fiber, and sugar derived from enzymatically hydrolysed cereal bran. By enzymatically hydrolysed cereal bran is meant cereal bran which has been contacted with hydrolysing enzymes in order to hydrolyse complex carbohydrates and proteins to yield a composition with the desired content of fat, dietary fiber, sugar and total carbohydrate. In a preferred embodiment, enzymatically hydrolysed cereal bran is cereal bran which has been contacted with an enzyme composition comprising xylanase, alpha-amylase, beta-glucanase, cellulase and endoprotease.

The food or beverage ingredient of the invention comprises 5-20% by weight of dry matter of protein derived from enzymatically hydrolysed cereal bran, preferably 7-15% by weight of dry matter. The food or beverage ingredient of the invention further comprises 0.1-15% by weight of dry matter of fat derived from enzymatically hydrolysed cereal bran; preferably 0.2-10% by weight of dry matter. Additionally, the food or beverage ingredient of the invention comprises 2-45% by weight of dry matter of dietary fiber derived from enzymatically hydrolysed cereal bran, preferably 3-15% by weight of dry matter. Dietary fiber is used here to refer to the portion of plant-derived food that are not broken down by human digestive enzymes and encompasses soluble and insoluble dietary fiber.

The food or beverage ingredient of the invention comprises 5-35% by weight of dry matter of sugar derived from enzymatically hydrolysed cereal bran; preferably 10-30% by weight of dry matter. By sugar in the present context is meant the total amount of mono- and di-saccharides. Furthermore, the food or beverage ingredient of the invention comprises 70-94% by weight of dry matter of total carbohydrate derived from enzymatically hydrolysed cereal bran, preferably 70-92%, more preferably 75-90% by weight of dry matter. By total carbohydrate is meant the total amount of carbohydrate including dietary fiber and sugar (mono- and di-saccharides) as well as any other carbohydrates including oligo- and polysaccharides, e.g. starch.

In a preferred embodiment of the invention said protein, fat, dietary fiber, sugar and total carbohydrate is derived from enzymatically hydrolysed cereal bran selected from the group consisting of hydrolysed rice, oat, corn, wheat, maize, barley, rye, millet, sorghum and triticale bran, and combinations thereof.

To be used as a replacer of glucose syrup it is preferable that the glass transition temperature of the food or beverage ingredient of the invention is similar to glucose syrup, e.g. in order to facilitate processing, e.g. drying, of food or beverage products produced with the ingredient, e.g. beverage creamers. In a preferred embodiment, the glass transition temperature of the food or beverage ingredient of the invention is 50-70° C. at a moisture content of 2-3% by weight.

### Creamer Composition

By a creamer composition is meant a composition intended to be added to a beverage or liquid food product, such as e.g. coffee, tea, bouillon and/or soup, and is usually used to impart colour, e.g. whitening, texture, taste and/or aroma to the beverage or liquid food product. Creamers are widely used as whitening agents and texture/mouthfeel modifiers for hot and cold beverages, e.g., coffee, cocoa, tea, etc. They are commonly used as an alternative to milk or dairy cream. Creamers may come in a variety of different flavours and provide a whitening effect, mouthfeel, body, a smoother texture, taste and/or aroma and may be in powdered or liquid form.

In one embodiment, the invention relates to a creamer composition comprising 35-90% by weight of dry matter of the food or beverage ingredient of the invention, preferably 50-80% by weight of dry matter of the food or beverage ingredient of the invention; and 10-45% by weight of dry matter of fat, preferably 20-40% by weight of dry matter of fat. The fat may be any suitable fat, e.g. milk fat, vegetable oil, or a combination thereof. Vegetable oil may e.g. be palm kernel oil, canola oil, soy bean oil, sunflower oil, safflower oil, cotton seed oil, palm oil, corn oil, coconut oil, or a combination thereof.

The creamer composition of the invention may further comprise one or more emulsifiers and/or one or more buffering agents.

The emulsifier may e.g. be selected from the group consisting of monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, lecithins, lysolecithins, succinic acid esters of mono- and/or diglycerides, lactic acid esters of mono- and/or diglycerides, lecithins, lysolecitins, proteins and sucrose esters of fatty acids, lecithin (e.g. soy lecithin, canola lecithin, sunflower lecithin, and/or safflower lecithin), lysolecithins, pectin, and combinations thereof.

The buffering agent can prevent undesired creaming or precipitation of the creamer upon addition into a hot, acidic environment such as coffee. The buffering agent can e.g. be monophosphates, diphosphates, sodium mono- and bicarbonates, potassium mono- and bicarbonates, or a combination thereof. Preferred buffers are salts such as potassium phosphate, dipotassium phosphate, potassium hydrophosphate, sodium bicarbonate, sodium citrate, sodium phosphate, disodium phosphate, sodium hydrophosphate, citric acid and sodium tripolyphosphate. The buffering agent may e.g. be present in an amount of about 0.1 to about 3% by weight of dry matter weight of the creamer.

A creamer composition according to the invention may further comprise protein, e.g. in the range 0.5-15% by weight of dry matter, such as 1.5-10% such as 1.5-5%. The protein may be any suitable protein, e.g. milk protein, such as casein, caseinate, and whey protein; vegetable protein, e.g. soy, oat, rice and/or pea protein; and/or combinations thereof. The protein in the composition may work as an emulsifier, provide texture, and/or provide whitening effect.

The creamer composition may comprise a hydrocolloid. Hydrocolloids may help to improve physical stability of the composition. Suitable hydrocolloids may e.g. be carrageenan, such as kappa-carragenan, iota-carragenan, and/or lambda-carragenan; starch, e.g. modified starch; cellulose, e.g. microcrystalline cellulose, methyl cellulose, or carboxy-methyl cellulose; agar-agar; gelatine; gellan (e.g., high acyl, low acyl); guar gum; gum Arabic; kojac; locust bean gum; pectin; sodium alginate; maltodextrin; tracaganth; xanthan; or a combination thereof.

The creamer composition (e.g. provided in the creamer component) of the present invention may further include one or more additional ingredients such as flavors, sweeteners, colorants, antioxidants (e.g. lipid antioxidants), or a combination thereof.

In a preferred embodiment, the creamer composition according to the invention is in the form of a powder, e.g. in the form of a spray dried powder, a roller dried powder, a freeze-dried powder, an agglomerated powder, or any other suitable from of powder or combination thereof. In a more preferred embodiment, the creamer composition according to the invention is in the form of a spray dried powder.

### Method of Producing a Food or Beverage Ingredient of the Invention

In a further aspect, the invention relates to a method of producing a food or beverage ingredient of the invention, the method comprising: contacting a slurry of cereal bran with an enzyme composition comprising xylanase, alpha-amylase, beta-glucanase, cellulase and endoprotease; allowing the enzyme composition to react for 30-240 minutes at 20-70° C.; and removing particulates from the enzyme treated slurry to produce a liquid food ingredient.

By xylanase is understood an enzyme with enzymatic activity of enzyme class EC 3.2.1.8, also called endo-1,4-beta-xylanase, which catalyses the endohydrolysis of (1->4)-beta-D-xylosidic linkages in xylans. A xylanase may have only xylanase activity or may additionally have one or more side activities, i.e. other enzymatic activities in addition to xylanase activity.

By alpha-amylase is understood one or more enzymes with enzymatic activity of enzyme class EC 3.2.1.1, which catalyses the endohydrolysis of (1->4)-alpha-D-glucosidic linkages in polysaccharides containing three or more (1->4)-alpha-linked D-glucose units. An alpha-amylase according to the invention may have only alpha-amylase activity or may additionally possess one or more side activities.

By cellulase is understood an enzyme with enzymatic activity of enzyme class EC 3.2.1.4 which catalyses the endohydrolysis of (1->4)-beta-D-glucosidic linkages in cellulose, lichenin and cereal beta-D-glucans and may also hydrolyze 1,4-linkages in beta-D-glucans also containing 1,3-linkages. A cellulase may have only cellulase activity or may additionally have one or more side activities, i.e. other enzymatic activities in addition to cellulase activity.

By beta-glucanase is understood an enzyme with enzymatic activity of enzyme class EC 3.2.1.6, also called endo-1,3 (4)-beta-glucanase, which catalyses the endohydrolysis of (1->3)- or (1->4)-linkages in beta-D-glucans when the glucose residue whose reducing group is involved in the linkage to be hydrolyzed is itself substituted at C-3.

By endoprotease, also called endopeptidase, is meant a protease that break peptide bonds of nonterminal amino acids (i.e. within the molecule), in contrast to exopeptidases, which break peptide bonds from end-pieces of terminal amino acids.

EC (Enzyme Committee) numbers refer to the definition of enzymatic activity and nomenclature given by the Nomenclature Committee of the International Union of Biochemistry and Molecular Biology.

By an “enzyme composition” is understood a composition comprising one or more enzymes and having one or more enzymatic activities. An enzyme composition may be derived from any suitable source. It may e.g. be in the form of an extract of microbial cells comprising the desired enzymatic activities, or it may e.g. be in the form of a mixture of extracts of two or more different microbial cells. Cell extracts may have undergone purification to remove undesired components, e.g. undesired enzymatic activities, and/or to increase the concentration of desired enzymes. The enzyme composition may also be a mixture of purified enzymes or it may be a mixture of one or more cell extracts and one or more purified enzymes.

Suitable enzymes may e.g. be from a microbial source (bacteria, fungi, yeast) e.g. from Aspergillus sp., Bacillus sp., Trichoderma sp., Cellulomonas Sp., Clostridium sp., Penicillium sp., Fusarium sp., Saccharomyces sp., Solanum sp., Vibrio sp., Streptomyces sp., Lactobacillus sp., and/or Rhizopus sp.; from an animal source e.g. from a marine invertebrate (such as scallop), a termite, an insect, a crayfish, a protozoan, a snail, and/or a crustacean; and/or from plant source, e.g. from marine algae, olives, and/or almonds.

According to the method of the invention a slurry of cereal brand is contacted with an enzyme composition. The slurry may be provided by mixing cereal bran with water in any ratio suited for the enzymatic hydrolysis, e.g. in a ratio of cereal bran to water of between 1:2 and 1:5. The slurry may be contacted with the enzyme composition in any suitable way, e.g. by mixing a liquid or powdered enzyme composition with the slurry. The enzyme composition may be added as a combined composition or one or more enzymes may be added individually to the slurry, e.g. in powder or liquid form.

The enzyme composition is allowed react for 30-240 minutes at 20-70° C. with the slurry, such that carbohydrates and proteins of the cereal bran is hydrolysed to obtain the desired composition. The temperature may be varied during the enzymatic reaction, e.g. to account for different temperature optima of the individual enzymes of the composition. For example, the temperature may be varied stepwise, e.g. in 3 steps. In a preferred embodiment, the enzyme composition is allowed to react at a temperature of 45-55° C. for 15-60 minutes, followed by at 55-65° C. for 30-120 minutes. In a more preferred embodiment, the enzyme composition is allowed to react at a temperature of 45-55° C. for 15-60 minutes, followed by at 55-65° C. for 30-100 minutes, followed by at 65-75° C. for 15-60 minutes. The reaction of the enzymes may be stopped when the desired composition has been achieved, e.g. by inactivation of the enzymes, e.g. by heat treatment to any temperature and for any time suitable for inactivating the enzymes being used, e.g. at 70-100° C. for 5-60 minutes.

Particulates are removed from the enzyme treated slurry to produce a liquid food ingredient. Particulates may e.g. be unhydrolyzed remains of cereal bran which is unwanted in the final food or beverage ingredient is removed. Particulates may be removed by any suitable method, e.g. by filtration or centrifugation. The liquid food or beverage ingredient may further be concentrated by any suitable method, preferably by evaporation.

### Method of Producing a Creamer Composition

In a yet further aspect, the invention relates to a method of producing a creamer composition of the invention, the method comprising contacting a slurry of cereal bran with an enzyme composition comprising xylanase, alpha-amylase, beta-glucanase, cellulase and endoprotease; allowing the enzyme composition to react for 30-240 minutes at 20-70° C.; removing particulates from the enzyme treated slurry to produce a liquid food ingredient; mixing said liquid food ingredient with fat to produce a liquid creamer composition.

The first part of the method involving the production of a liquid food ingredient is identical to the method of producing a food or beverage ingredient as disclosed in the foregoing paragraphs. The food or beverage ingredient produced in this way is mixed with fat to produce a creamer composition. The fat may be any suitable fat as disclosed above in relation to a creamer composition and any further components suitable for inclusion in a creamer composition as disclosed above may further be mixed into the creamer composition. Mixing of components may be achieved by any suitable way known in the art. For example, fat may be mixed into an aqueous suspension of one or more emulsifiers, one or more buffering salts, one or more hydrocolloids and/or one or more proteins, to produce an emulsion of oil in water. This emulsion may be mixed with the food or beverage ingredient of the invention. The mixture may further be heat treated to ensure microbiological safety and/or homogenized to ensure good dispersion and stability.

In a preferred embodiment, the creamer composition is dried to produce a powdered creamer composition, e.g. by spray drying, roller drying, or freeze-drying. In a further preferred embodiment, is spray dried to produce a powdered creamer composition.

### EXAMPLES

### Example 1 Production of a Food or Beverage Ingredient

Oat bran with 16.8% protein, 9.8% fat, 45.9% carbohydrates and 14.8% dietary fiber was used as the substrate for hydrolysis. A slurry was prepared with bran to water ratio of 1:3, and following enzymes added: 0.25% of FoodPro CBL (beta-glucanase, cellulase and xylanase), 0.075% of NZ26210 (alpha-amylase), and 0.5% FoodPro Alkaline Protease (endoprotease). pH was adjusted to 5.5 using hydrochloric acid (5M), and the slurry was kept at 50° C. for 30 min. After that, temperature was ramped up to 60° C. with 1° C./min, then kept at 60° C. for 60 min. Then, ramped up to 68° C. with 1° C./min, and kept at 68° C. for 30 min. Last, ramped up to 80° C. with 1° C./min, and kept at 80° C. for 10 min. The reaction mixture then went through a filtration system, with the following parameters: filter pressure at 0.4 bar; leaching pressure at 0.8 bar; pre-compression at 0.6 bar; and final compression at 0.8 bar. The wort was then transferred to a falling film evaporator, with 4 bar air. The final solids content of the syrup was between 70%-81% with water activity that was less than 0.8.

Rice bran syrup was prepared using a mixture containing rice bran and rice husk (3:1). A slurry was prepared with bran/husk to water ratio of 1:3, and following enzymes added: 1% of FoodPro CBL (beta-glucanase, cellulase and xylanase), 0.8% of NZ26210 (alpha-amylase), and 0.3% FoodPro Alkaline Protease (endoprotease). pH was adjusted to 5.5 using hydrochloric acid (5M), and the slurry was kept at 50° C. for 30 min. After that, temperature was ramped up to 60° C. with 1° C./min, then kept at 60° C. for 60 min. Then, ramped up to 68° C. with 1° C./min, and kept at 68° C. for 30 min. Last, ramped up to 80° C. with 1° C./min, and kept at 80° C. for 10 min. The reaction mixture then went through a filtration system, with the following parameters: filter pressure at 0.4 bar; leaching pressure at 0.8 bar; pre-compression at 0.6 bar; and final compression at 0.8 bar. The wort was then transferred to a falling film evaporator, with 4 bar air. The final solids content of the syrup was between 70%-81% with water activity that was less than 0.8.

Corn bran syrup was prepared using corn bran pellets. A slurry was prepared with bran to water ratio of 1:3, and following enzymes added: 1% of Grindamyl H490 (xylanases), 1% of NZ26210 (alpha-amylase), and 0.3% FAN Boost (endoprotease). The slurry was kept at 50° C. for 30 min. After that, temperature was ramped up to 60° C. with 1° C./min, then kept at 60° C. for 80 min. Last, ramped up to 80° C. with 1° C./min, and kept at 80° C. for 30 min. The reaction mixture then went through a filtration system, with the following parameters: filter pressure at 0.4 bar; leaching pressure at 0.8 bar; pre-compression at 0.6 bar; and final compression at 0.8 bar. The wort was then transferred to a falling film evaporator, with 4 bar air. The final solids content of the syrup was between 70%-81% with water activity that was less than 0.8.

### Example 2 Chemical Composition

Chemical composition of the hydrolysed cereal brans
(syrups) produced in example 1 (dry basis)

| | | | | | Total |
|---|---|---|---|---|---|
| Syrup | Protein | Fiber | Fat | Sugar | Carbohydrate |
| Oat Bran Syrup | 15% | 9% | 8% | 14% | 76% |
| Rice Bran Syrup | 9% | 5% | 0.3% | 25% | 86% |
| Corn Bran Syrup | 7% | 4% | 0.1% | 29% | 90% |

### Methods Used:

Protein (N×6.25) Kjeldahl method (PGEN_S)

Official Methods and Recommended Practices of the American Oil Chemists' Society, Champaign, IL, Official Methods Ac 4-91

(2011). (Modified)

Total Dietary Fiber (IDFM_S)

Official Methods of Analysis, Method 2011.25, AOAC INTERNATIONAL (modified).

Fat by Acid Hydrolysis (FAT_AH_S)

Food Products that are not Dairy, Egg or Cheese Products

Official Methods of Analysis of AOAC INTERNATIONAL (2005) 18TH Ed., AOAC, INTERNATIONAL, Gaithersburg, MD, USA,

Official Methods 922.06 and 954.02. (Modified)

Sugar Profile By Ion Chromatography (SGIC_2_S)

Ellingson, D., Anderson, P., Berg, D., “Analytical Method for Sugar Profile in Pet Food and Animal Feeds by High—

Performance Anion-Exchange Chromatography with Pulsed Amperometric Detection”, Journal of AOAC

INTERNATIONAL 99 (2): 342-352 (2016) (modified).

Carbohydrates (CHO)

United States Department of Agriculture, “Energy Value of Foods”, Agriculture

Handbook No. 74, pp. 2-11, (1973).

Moisture by M100_T100 (M100T100_S)

Official Methods of Analysis of AOAC INTERNATIONAL, 18th Ed., Methods 925.09 and 926.08, AOAC INTERNATIONAL, Gaithersburg, MD, USA, (2005). (Modified).

### Example 3 Powdered Creamer Compositions

Beverage creamer compositions were produced using each of the food or beverage ingredients (cereal bran syrups) produced in example 1.

Buffer salts were solubilized in water (0.7% Citric acid and 1.5% sodium bicarbonate). Once solubilization was completed, milk protein (1.89% sodium caseinate) was added until complete suspension (around 10 min). These steps were done under continuous agitation at 60-70° C. In parallel, the oily phase was prepared separately, composed of 30.15% palm kernel oil and 0.8% sunflower lecithin, under agitation at around 60-70° C. The two phases, water and oil were added together. The Bran syrup (64.96%) was incorporated (pre-heated at around 60° C.). The concentrate had a total solid of around 60%. Viscosity was measured as described. The concentrate was submitted to heat treatment, 81° C. for 25 seconds before going to the homogenization step. Homogenization settings were 180/50 bar for 1st/2nd stage. The heat-treated and homogenized slurry proceeded to the spray dryer to evaporate the excess water until getting a powder creamer of max 3% water content. Glass transition temperature was measured as described. All percentages are by weight of dry matter, except for water which is by total weight.

### Results

Table below shows the results of creamer concentrate viscosity measured before drying for the creamers produced above and a reference creamer produced in the same way but using glucose syrup in place of the food or beverage ingredient of the invention (HAKKE RheoWin, RS6000). For good processing, concentrate viscosity should not be too high to prevent spraying or too thin to cause excess of fines in the creamer powder resulting in processing issues and bad in-cup reconstitution. The table shows the results of concentrate viscosity versus shear rate for concentrates at comparable Total solids (TS). All are within sprayable range of 30-100 mPa·s at 500-600 l/s.

| | Glucose | Oat | Rice | Corn |
|---|---|---|---|---|
| Shear | Syrup | Syrup, | Syrup, | Syrup, |
| rate | mPa · s | mPa · s | mPa · s | mPa · s |
| (1/s) | (61.8% TS) | (60.1% TS) | (60% TS) | (60% TS) |
| 100 | 51.6 | 141.3 | 61.76 | 33.1 |
| 200 | 49.82 | 106.2 | 45.3 | 30.74 |
| 300 | 44.62 | 91.22 | 37.38 | 28.56 |
| 400 | 44.43 | 81.86 | 33.9 | 28.34 |
| 500 | 45.04 | 75.55 | 32.18 | 28.54 |
| 600 | 45.47 | 71.37 | 32.2 | 28.93 |

Onset of Glass Transition temperature was measured in the final powder. Results are shown in the table below by Differential scanning calorimetric method and indicate that the product can be spray dried to obtain a powder coffee creamer using the syrups.

| | Onset of Glass |
|---|---|
| | Transition |
| | (° C.) at a given |
| | powder moisture |
| | content (%) |
| Glucose Syrup | 65.93 @ 2.78 |
| (22-26 DE) | |
| Oat Syrup | 65.86 @ 2.48 |
| Rice Syrup | 55.00 @ 2.36 |
| Corn Syrup | 51.01 @ 2.49 |

Sensory characteristics were evaluated by trained panellists. Recipes were set to 22% Pure soluble coffee and 68% of creamer without any flavour or modifiers. The creamers according to the invention was tested versus the reference creamer produced with glucose syrup. No significant off-notes were detected and all creamers had acceptable sensory profiles.

1: A method of producing a food or beverage ingredient, the method comprising:
contacting a slurry of cereal bran with an enzyme composition comprising xylanase, alpha-amylase, beta-glucanase, cellulase and endoprotease;
allowing the enzyme composition to react with the slurry for 30-240 minutes at 20-70° C. to form an enzyme-treated slurry; and
removing particulates from the enzyme-treated slurry to produce the liquid food or beverage ingredient.

2: The method of claim 1 further comprising concentrating the liquid food or beverage ingredient.
